(19) United States
(12) Patent Application Publication
(10) Pub. No.: US 2023/0205849 A1
(43) Pub. Date: Jun. 29, 2023

(54) DIGITAL AND PHYSICAL ASSET TRACKING AND AUTHENTICATION VIA NON-FUNGIBLE TOKENS ON A DISTRIBUTED LEDGER

(71) Applicant: Total Network Services Corp., Carlsbad, CA (US)

(72) Inventors: Kevin L. JACKSON, Manassas, VA (US); Thomas N. CARTER, Vista, CA (US)

(21) Appl. No.: 17/899,258

(22) Filed: Aug. 30, 2022

Related U.S. Application Data
(60) Provisional application No. 63/239,879, filed on Sep. 1, 2021.

(51) Int. Cl. G06F 21/10; H04L 9/00

(52) U.S. Cl. CPC G06F 21/10; H04L 9/50

(57) ABSTRACT

Methods, systems, and apparatus, including computer programs encoded on a computer storage medium, for tracking assets are disclosed. In one aspect, a method includes the actions of receiving data identifying an asset. The actions further include generating a first hash of the asset. The actions further include generating an NFT that includes metadata that includes the first hash of the asset and the data identifying the asset. The actions further include storing the NFT on a distributed ledger. The actions further include receiving a request to access the asset. The actions further include generating a second hash of the asset. The actions further include accessing the NFT based on the metadata of the NFT including the data identifying the asset. The actions further include comparing the first hash included in the metadata of the NFT to the second hash. The actions further include determining whether the asset has been modified.

### CROSS-REFERENCE TO RELATED APPLICATION

This application claims the benefit of U.S. Application 63/239,879, filed Sep. 1, 2021, which is incorporated by reference.

### BACKGROUND

A distributed ledger is a consensus of replicated, shared, and synchronized digital data geographically spread across multiple sites, countries, or institutions. A blockchain is a type of distributed ledger and is a growing list of records, called blocks, that are securely linked together using cryptography. Each block contains a cryptographic hash of the previous block, a timestamp, and transaction data. The timestamp proves that the transaction data existed when the block was published to get into its hash. As blocks each contain information about the block previous to it, they form a chain, with each additional block reinforcing the ones before it. Blockchains may be resistant to modification of their data because once recorded, the data in any given block cannot be altered retroactively without altering all subsequent blocks.

A non-fungible token (NFT) is a security token consisting of digital data stored in a blockchain. The ownership of an NFT is recorded in the blockchain, and can be transferred by the owner, allowing NFTs to be sold and traded.

### BRIEF DESCRIPTION OF THE DRAWINGS

The detailed description is described with reference to the accompanying figures, in which the left-most digit(s) of a reference number identifies the figure in which the reference number first appears. The use of the same reference numbers in different figures indicates similar or identical items.

FIG. 1 illustrates an example system that is configured to track assets and provide data indicating whether the assets have been modified.

FIG. 2 illustrates an example server that is configured to track assets and provide data indicating whether the assets have been modified.

FIG. 3 is a flowchart of an example process to track assets and provide data indicating whether the assets have been modified.

### DETAILED DESCRIPTION

This disclosure describes techniques that facilitate digital asset tracking of digital media files, using non-fungible tokens (NFTs) stored on a distributed ledger. An NFT asset controller is described that can associated NFTs to digital assets (e.g., digital media files) to provide verifiable proof of ownership. While the NFT asset controller is described as a standalone controller, the functionality and operations of the NFT asset controller can be implemented via an application native to any electronic device capable of interacting with a distributed ledger via one or more network(s).

In one embodiment, the techniques describe generating an NFT for a digital asset that can be used to verify the authenticity of the digital asset. The digital asset may comprise multimedia data (e.g., audio, video, image) or literary data that is available via a public or private network. The digital asset may further comprise log files, transaction histories, or any other suitable data file that can be accessed, created, modified, or transmitted via an electronic device. The NFT comprises a cryptographic token, namely a unit of data that is not mutually interchangeable, and that can be stored on a distributed ledger blockchain. While digital assets themselves are infinitely reproducible, a particular instantiation of a digital asset that is tied to an NFT is uniquely distinguished from reproduced instances.

In one example, an NFT asset controller may create a cryptographic token (e.g., digital asset NFT) for the digital asset, based on a cryptographic hash of the digital asset. The cryptographic token (e.g., digital asset NFT) may be based on an entirety of the digital asset, or a portion that is less than an entirety of the digital asset. In either case, the cryptographic token is intended to uniquely identify the instance of the digital asset. The digital asset may be tagged (e.g., digital asset metadata) with the digital asset NFT, such that the authenticity, ownership, and access rights of the digital asset follow the digital asset.

The digital asset NFT may be uploaded into a distributed ledger, such as a blockchain, to verifiably memorialize the NFT and its association with the digital asset. The distributed ledger may be a data structure that is used to store data records associated with an NFT. Generally, distributed ledger systems are configured to store tamper-resistant records of previously verified transactions or computer code executions. One example of a distributed ledger is a blockchain. A blockchain comprises a series of connected data structures, referred to as blocks. A blockchain comprises a series of connected data structures, referred to as blocks. Each block contains a set of one or more data records and a header. The header includes a hash derived from the payload of the block and a hash of the previous block.

The blockchain storing the digital asset NFT may include asset information associated with the digital asset. The asset information may include proof of authenticity, proof of ownership, or a suitable combination of both. Asset information may further include access controls that control access rights to the digital asset. Access rights may regulate, which electronic devices may access the digital asset. In some embodiments, to access a digital asset, electronic devices may need to prove ownership or access rights via their own electronic device NFTs.

By way of example, consider an audio stream available via an online service. The audio stream may be publicly available in an abridged instance, and access to an unabridged instance may be tied to verifying ownership or access rights via an NFT of the audio stream. The abridged instance may permit playback for a segment of the audio stream that is less than its entirety. Alternatively, or additionally, the abridged instance may permit playback of a low bitrate of the audio stream. The audio stream may be configured such that to access the unabridged instance (e.g., an entirety of the audio stream, relatively higher bitrate of the audio stream), the audio stream requires a cryptographic key. The cryptographic key may be stored within the blockchain associated with the audio stream NFT. Once an electronic device can provide proof of ownership of access rights, the cryptographic key may be sent to the electronic device to permit payback of the unabridged instance on the electronic device. In some examples, proof of ownership may be based on an electronic device NFT. The electronic device NFT may be based on a Mobile Equipment Identifier (MEID) of the electronic device. The MEID is a globally unique 56-bit identification number that is associated with an electronic device, typically, memory integrated into the physical structure (e.g., a motherboard, a main board, a system board, etc.) of the mobile device, enabling consumers and vendors to identify and track an electronic device. Use of a MEID as proof of ownership and to control access rights provides control and access, at a per-device level, to the digital asset. Further, an NFT that is based on a MEID ensures that cloned or counterfeit electronic devices that purport to hold a MEID with access to a digital asset, are not inadvertently provided access rights to the unabridged digital asset.

In a second embodiment, the techniques describe generating an NFT for a physical asset that can be used to verify the authenticity of the physical asset. The physical asset may comprise an article of clothing or any other tangible product or thing. In this embodiment, an NFT asset controller may create a cryptographic token (e.g., physical asset NFT) for the physical asset based on asset information of the physical asset. Asset information may comprise a “unique signature” associated with the physical asset. The unique signature may be an image captured of an entirety of the physical asset or an image captured of a portion that is less than an entirety of the physical asset. The image may include features unique to the instance of the physical asset, such as a “signed” clothing article. Asset information may also include a Radio Frequency Identification Tag (RFID) tag or a Quick Response (QR) code tag. The RF tag or the QR code may be used to uniquely identify a particular physical asset relative to other similar instantiations.

It is noteworthy that NFTs are generated using a one-way function (e.g., cryptographic hash). In other words, the NFT itself cannot be used to reconstitute the asset information upon which it was based. For example, an NFT created based on an image of a “signed” clothing article cannot be used re-generate the image of the “signed” clothing article. That said, the benefit of a blockchain is that the asset information can be stored alongside the NFT in the initial block of the blockchain. As a result, any question of authenticity (e.g., NFT is inadvertently associated with a counterfeit physical asset), can be resolved by referring to the initial block of the blockchain.

Alternatively, or additionally, a hash value in the NFT of a physical asset may be etched onto the physical asset or stored within an RFID tag, or similar electronic component, that is fixedly connected to the physical asset. In this way, the physical asset NFT is inextricably tied to the physical asset in the same way that a digital asset NFT is stored within the metadata of a digital asset.

The NFT asset controller may be configured to generate the NFTs for digital assets and physical assets based on respective asset information. Further, the NFT asset controller may be configured to incorporate NFTs onto a blockchain. Each change in ownership of a digital or physical asset may comprise a subsequent block in the blockchain. The NFT asset controller may be further configured to associated metadata with digital assets. Metadata may include a timestamp and the geolocation identifying when and where a digital asset was accessed, created, modified, or transmitted via an electronic device.

The electronic device may include any sort of electronic devices, such as a television unit, a multimedia streaming device, a cellular phone, a smartphone, a tablet computer, an electronic reader, a media player, a gaming device, a personal computer (PC), a laptop computer, etc. The electronic device may also include network devices that act as intermediaries with the Internet. It is noteworthy that the Internet is accessible via one or more network(s). In some examples, the operator device and the user device may include a subscriber identity module (SIM), such as an eSIM, to identify each device to a telecommunication service provider (also referred to herein, as “telecommunications network”).

The NFT asset controller may operate on one or more distributed computing resource(s). The one or more distributed computing resource(s) may include one or more computing device(s) that operate in a cluster or other configuration to share resources, balance load, increase performance, provide fail-over support or redundancy, or for other purposes. The one or more computing device(s) may include one or more interfaces to enable communications with other networked devices via one or more network(s).

The one or more network(s) may include public networks such as the Internet, private networks such as an institutional and/or personal intranet, or some combination of a private and public network(s). The one or more network(s) can also include any type of wired and/or wireless network, including but not limited to local area network (LANs), wide area network(s) (WANs), satellite networks, cable networks, Wi-Fi networks, Wi-Max networks, mobile communications networks (e.g., 5G-NR, LTE, 3G, 2G), or any combination thereof.

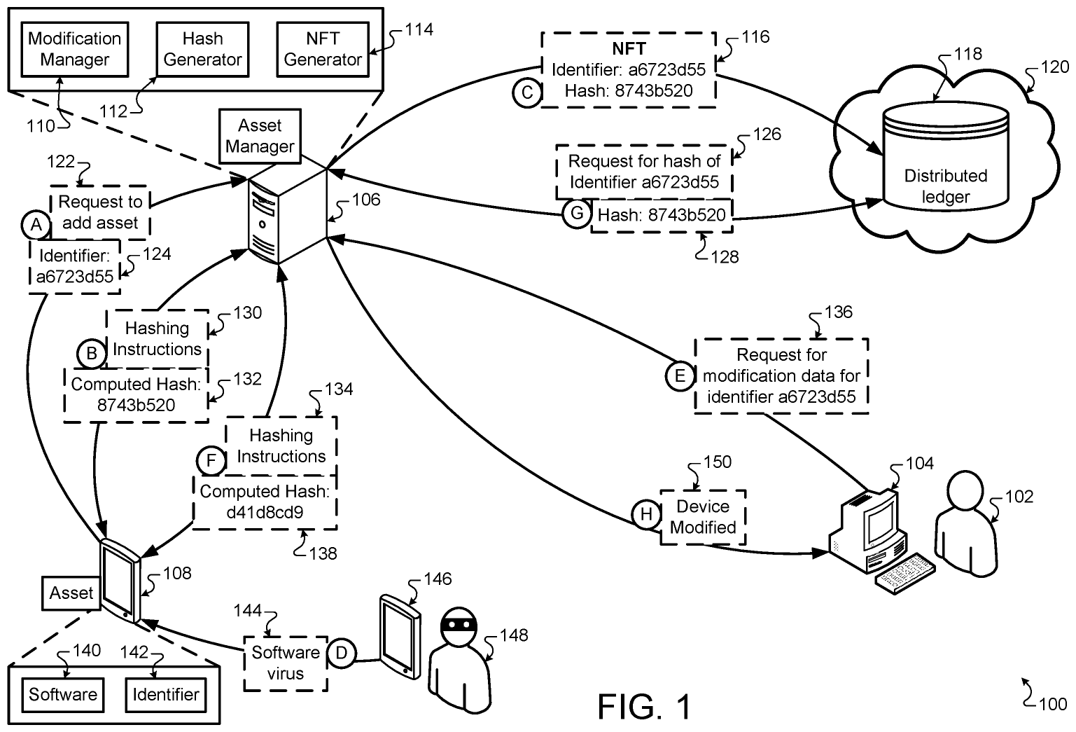

FIG. 1 illustrates an example system 100 that is configured to track assets and provide data indicating whether the assets have been modified. Briefly, and as described in more detail below, the system 100 includes an asset manager 106 that is configured to track and monitor various assets such as asset 108. The asset 108 may be a virtual asset or a physical asset. The asset manager 106 generates a hash for each asset and stores the hash in the distributed ledger 118. The user 102 may request information from the asset manager 106 regarding whether the asset 108 has been modified from the time the asset manager 106 recorded the asset 108 from the time that the user 102 requested the information related to the asset 108. FIG. 1 includes various stages A through H that may illustrate the performance of actions and/or the movement of data between various components of the system 100. The system 100 may perform these stages in any order.

In more detail and in stage A, the asset manager 106 may receive a request 122 to begin tracking the asset 108. The request 122 may include an identifier packet 124 that includes the identifier 142 of the asset 108. The asset manager 106 may be any type of computing device that is capable of communicating with other computing devices. For example, the asset manager 106 may be a desktop computer, laptop computer, mobile phone, smart watch, tablet, and/or any other similar type of device. In some implementations, the asset manager 106 may be a virtual computing device that is instantiated in the cloud. A physical asset may be a computing device such as a desktop computer, laptop computer, mobile phone, smart watch, tablet, and/or any other similar type of device. A virtual asset may be an NFT or other similar type of asset.

The asset 108 may transmit the request 122 in response to a user input. The user may access multiple assets and request that each of the assets transmit a request to the asset manager 106. In some implementations, the asset 108 may be configured to automatically transmit the request 122. For example, the asset 108 may automatically transmit the request 122 upon booting for the first time. As another example, the asset 108 may automatically transmit the request 122 upon executing a specific software program, connecting to a specific network, and/or perform any other various actions.

The asset 108 may include the identifier 142 and software 140. The software 140 may be any type of software that is stored and/or accessible by the asset 108. For example, the software 140 may be the operating system of the asset 108, the contents of the non-volatile memory on the asset 108, and/or any other similar software. The identifier 142 may be any unique identifier of the asset. The identifier 142 may be a serial number that may be combined with a model. The identifier 142 may be MEID, international mobile equipment identifier, phone number, and/or any other unique identifier. In some implementations, the identifier 142 may be immutable. In the example of FIG. 1, the identifier 142 is 0xa6723d55.

The asset manager 106 may include a modification manager 110. The modification manager 110 may be implemented by one or more physical or virtual processors executing instructions stored in and/or accessible by the asset manager 106. The modification manager 110 may be configured to receive the request 122 and begin the process of recording data related to the asset 108 on the distributed ledger 118. This process may include coordinating with the hash generator 112 and the NFT generator 114 of the asset manager 106. Each of the hash generator 112 and the NFT generator 114 may be implemented by one or more physical or virtual processors executing instructions stored in and/or accessible by the asset manager 106.

The modification manager 110 may be configured to analyze the identifier 142 in the identifier packet 124 and determine whether the identifier 142 matches any previous identifiers. The previous identifiers may be stored in the distributed ledger 118. The identifier 142 and other identifiers may be selected such that no two identifiers are identical. Even in this case, the modification manager 110 may confirm that the identifier 142 is not the same as any identifiers stored in the distributed ledger 118. If the modification manager 110 does determine that the identifier 142 matches a previous identifier, then the modification manager 110 may add a prefix and/or suffix to the identifier 142. The prefix and/or suffix may be a random collection of bytes, the model of the asset 108, and/or any similar data that is sufficient to make the identifier 142 unique.

The modification manager 110 may provide instructions to the hash generator 112. The instructions may include for the hash generator 112 to generate a hash of the asset 112. The hash generator 112 may generate the hash of the asset 108 by identifying the data to input into the hash function. The hash generator 112 may identify the data based on the type of asset. For a physical asset that stores software, the hash generator 112 may generate a hash using the data stored on the physical asset. In the example of FIG. 1, the data stored on the physical asset 108 may include the software 140. For a virtual asset, the hash generator 112 may generate a hash using the data of the virtual asset. For an audio file, the data of the virtual asset may be the audio file itself. For an NFT, the data of the virtual asset may include the asset associated with the NFT, such as an image, video, and/or audio file and/or any extra data related to the block in the block chain where the NFT is located. The extra data may include the hash of the previous block, a timestamp, and/or any other data stored in the block.

In the example of FIG. 1 and in stage B, the modification manager 110 provides the hash generator 112 with an instruction to generate a hash of the asset 108. The hash generator 112 determines that the asset 108 is a mobile phone, which may include the model of the mobile phone. The hash generator 112 may determine the type of the asset 108 based on a communication with the modification manager 110 and/or by communicating with the asset 108. Based on determining that the asset 108 is a mobile phone, the hash generator 112 generates the hashing instructions 130 that indicate to compute the hash of the data stored in the non-volatile memory of the asset 108. In this case, the data stored in the non-volatile memory of the asset 108 software 140 is the software 140. The software may also include the MEID and/or any other similar identifier stored in a storage device of the memory. The hashing instructions 130 may also include a hashing algorithm such as Message Digest 5 (MD5), Secure Hashing Algorithm (SHA) 1 or 2, and/or any other similar hashing function.

The asset 108 may receive the hashing instructions 130. The asset 108 may execute the hashing instructions 130 by computing the hash 132 of the software 140. The hash 132 may include the hash value 0x8743b520. The asset 108 may provide the hash 132 to the asset manager 106. In some implementations, the asset 108 may provide the data to hash directly to the hash generator 112 of the asset manager 106. In this case, the hash generator 112 may transmit hashing instructions 130 that identify the data to hash and a request to transmit that data to the hash generator 112. The hash generator 112 may receive the data and generate the hash.

The modification manager 110 may transmit the identifier 142 to the NFT generator 114, and the hash generator 112 may transmit the hash 132 to the NFT generator 114. The modification manager 110 may also transmit instructions to the NFT generator 114 to generate an NFT based on the asset 108. The instructions may include the various metadata to include in the NFT. The metadata may include various data related to the asset 108 and may depend on the type of the asset 108. The data related to the asset 108 may include the identifier 142, the hash 132 of the asset 108, the location of the asset 108, the owner of the asset 108, the phone number of the asset 108, the model of the asset 108, an author of the asset 108, data identifying the blockchain where the asset 108 is located, data identifying the location in the blockchain where the asset 108 is located, authorized users of the asset 108, a type of data stored in the asset 108, a value of the asset 108, a purchase price of the asset 108, data identifying previous modifications of the asset 108, data identifying users who previously modified the asset 108, and/or any other similar data related to the asset 108.

In some implementations, the NFT generator 114 may determine the data to include in the metadata based on the type of the asset 108. For example, if the NFT generator 114 determines that the asset 108 is a mobile phone, then the NFT generator 114 may determine to include the identifier 142 and the hash 132. If the NFT generator 114 determines that the asset 108 is an NFT, then the NFT generator 114 may determine to include the identifier 142, the hash 132, the data identifying the blockchain where the asset 108 is located, data identifying the location in the blockchain where the asset 108 is located, a type of data stored in the NFT, and/or any other similar data. The type of data stored in the NFT may include audio data, video data, image data, text data, and/or any other similar type of data.

In the example of FIG. 1 and in stage C, the NFT generator 114 may receive the identifier 142 from the modification manager 110 and the hash 132 from the hash generator 112. The NFT generator 114 may generate the NFT 116. Based on the asset 108 being a mobile phone, the NFT generator 114 may include, in the metadata of the NFT 116, the identifier 142 and the hash 132. The NFT generator 116 may store the NFT 116 in the distributed ledger 118. In some implementations, the distributed ledger 118 may be a blockchain located in the cloud 120.

With the NFT 116 stored in the distributed ledger 118, the asset manager 106 may add additional NFTs for additional assets to the distributed ledger 118. The asset manager 106 may also provide data stored in the distributed ledger 118 to a requesting party. The requesting party may be interested in verifying the integrity of an asset and may want to determine the state of the asset at a previous point in time.

In some instances, the asset 108 may be modified by a nefarious actor 148. The nefarious actor 148 may access the asset 108 and load a software virus 144, other malware, tracking software, and/or any other data that may or may not have negative consequences. In some instances, the nefarious actor 148 may attempt to store benign data on the asset 108. Some assets may be easier for the nefarious actor 148 to access and/or modify. For example, an asset that is an NFT may be difficult to modify because modifying may break the blockchain where the NFT is located. Other assets may be easier to modify because they may not have an anti-tamper feature. For example, the nefarious actor 148 may be able to directly interact with a physical asset and load or remove data from the physical asset.

In the example of FIG. 1 and in stage D, the nefarious actor 148 may use the computing device 146 to load a software virus 144 onto the asset 108. In this case, the nefarious actor 148 may be able to use the computing device 146 to access the asset 108 directly, through a network, and/or through any other similar technique. The software virus 144 may be stored with the software 140 and/or in volatile or non-volatile memory.

After a period of time, the user 102 may be interested in acquiring the asset 108. The user 102 may wish to confirm that the asset 108 has not been modified for a period of time. For example, the user 102 may wish to confirm that the asset 108 has not been modified since it left the manufacturing facility, left a distribution warehouse, for at least a year, and/or any other similar marker. The user 102 may interface with the computing device 136 that is configured to communicate with the asset manager 106. The user 102 may identify the asset 108 as one of the assets that the user 102 is interested in verifying has not been modified. The computing device 104 may generate and transmit a request 136 for modification data related to a specific asset. In some implementations, the user 102 may provide the identifier for the asset. In some implementations, the user 102 may provide other information that may allow the computing device 104 to determine the corresponding identifier for the asset. For example, the user 102 may provide a model and serial number fora mobile phone. The computing device 104 may determine the MEID for that mobile phone. The computing device 104 may communicate with the asset manager 106 to determine the appropriate identifier. The computing device 104 may provide data identifying an appropriate identifier to the user 102.

In the example of FIG. 1 and in stage E, the user 102 may interact with the computing device 104. The user 102 may request to determine whether the asset with identifier 0xa6723d55 has been modified since the time that the asset manager 106 received the request to track the asset 108. The asset manager 106 may receive the request 136 and initiate the process to providing modification data 150 to the computing device 104.

In response to receiving the request 136, the asset manager 106 may communicate with the distributed ledger and the asset 108. The modification manager 110 may attempt to determine whether the asset 108 has been modified since the asset manager 106 recorded the asset 108. To make this determination, the modification manager 110 may determine a current hash of the asset 108 and access the previous hash of the asset 108. If the two hashes match, then that matching indicates that the asset 108 has not been modified. If the two hashes do not match, then that lack of matching indicates that the asset 108 has been modified.

The modification manager 110 may provide instructions to the hash generator 112 to determine the hash of the asset 108. The hash generator 112 may utilize a similar process described above with respect to stage B to determine the hash of the asset 108. In the example of FIG. 1 and in stage F, the hash generator 112 may generate the hash instructions 134. These hash instructions 134 may be similar to the hash instructions 130 and may indicate a hashing algorithm and specify the data to hash. The hashing instructions 134 may indicate to hash the data stored in the non-volatile memory of the asset 108. The asset 108 may perform the hash function on the data stored in the non-volatile memory of the asset 108, which may include the software 140 and the software virus 144. The resulting hash 138 may be 0xd41d8cd9. The asset 108 may provide the hash 138 to the hash generator 112. The hash generator 112 may provide the hash 138 of the asset 108 to the modification manager 110.

The modification manager 110 may also access the distributed ledger 118 to determine the previous hash stored in the NFT 116. The modification manager 110 may generate request 126 that includes the identifier of the asset 108. The distributed ledger 118 may output the hash 128 stored in the NFT 116 of the distributed ledger 118. In some implementations, the modification manager 110 may also request data indicating when the distributed ledger 118 stored the NFT 116. In some implementations, the request 126 may also include instructions to provide any metadata stored in the NFT that corresponds to the identifier in the request 126.

In the example of FIG. 1 and in stage G, the modification manager 110 may generate the request 126. The request 126 may include the identifier of the asset 108 and instructions to return the hash stored in the metadata of the corresponding NFT that includes the identifier of the asset 108 in the metadata. The distributed ledger 118 may receive the request 126 and identify the NFT that includes the identifier of the asset 108 in the metadata of the NFT. The distributed ledger 118 may identify the NFT 116 as the NFT that includes the identifier of the asset 108. The distributed ledger 118 may generate the hash packet 128 that includes the hash 0x8743b520. The distributed ledger 118 may transmit the hash packet 128 to the asset manager 110.

The modification manager 110 may receive the hash packet 128 and the hash packet 138. The modification manager 110 may compare the two hashes. If the two hashes match, then the modification manager 110 may determine that the asset 108 has not been modified since the asset manager 106 recorded the asset 108 in the distributed ledger. If the two hashes do not match, then the modification manager 110 may determine that the asset 108 has been modified since the asset manager 106 recorded the asset 108 in the distributed ledger. The modification manager 110 may generate a modification notice packet 150 that indicates whether the asset 108 has been modified.

In the example of FIG. 1 and in stage H, the modification manager 110 may compare the hash 0x8743b520 in the hash packet 128 to the hash 0xd41d8cd9 in the hash packet 138. The modification manager 110 may determine that the asset 108 has been modified. The modification manager 110 may generate the modification notice packet 150 that indicates that the asset 108 has been modified. The modification manager 110 may transmit the modification notice packet 150 to the computing device 104. The computing device 104 may output data indicating that the asset 108 has been modified.

In some implementations, the modification manager 110 may include additional information in the modification notice packet 150. The additional information may include any of the metadata stored in the NFT 116, a timestamp when the NFT was stored in the distributed ledger 118, a timestamp when the hash 132 of the asset 108 was computed, and/or any other similar metadata that may be stored in the NFT 116.

In some implementations, the computing device 104 may be configured to communicate with the distributed ledger 118 directly. In this case, the asset manager 106 may provide the computing device 104 data identifying the NFT 116 on the distributed ledger 118. The computing device 104 may communicate with the distributed ledger 118 to determine the hash of the asset 108. The computing device 104 may also communicate directly with the asset 108. In this case, the computing device 104 may compute the hash of the asset 108 and compare the hash of the asset 108 to the hash in the NFT 116 on the distributed ledger 118. The asset manager 106 may provide data identifying the hash function do the computing device 104. In this way, the computing device 104 may not need to rely on the asset manager 106 to accurately transmit hash data. The computing device 104 may verify the hash data independently.

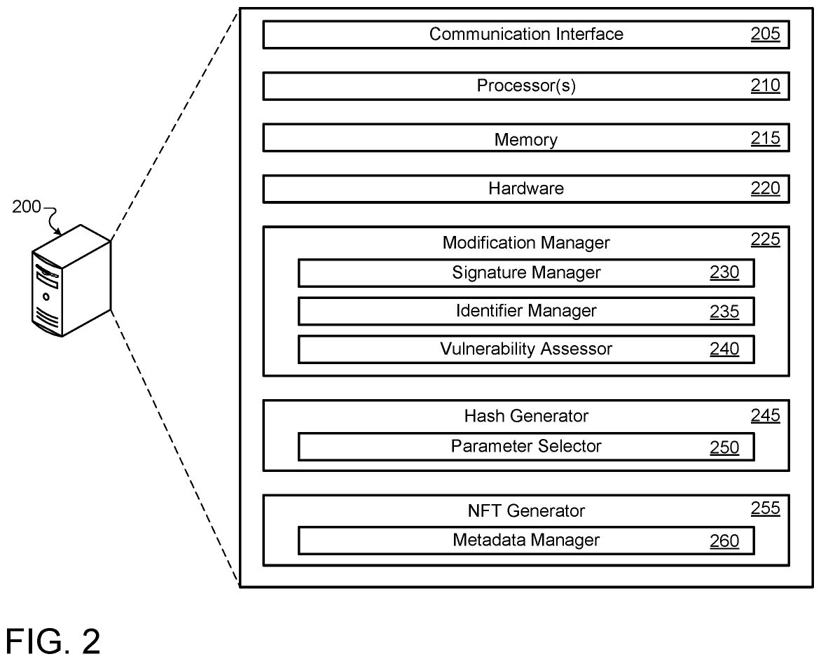

FIG. 2 illustrates an example server 200 that is configured to track assets and provide data indicating whether the assets have been modified. The server 200 may be any type of computing device that is configured to communicate with other computing devices. The server 200 may communicate with other computing devices using a wide area network, a local area network, the internet, a wired connection, a wireless connection, and/or any other type of network or connection. The wireless connections may include Wi-Fi, short-range radio, infrared, and/or any other wireless connection. The server 200 may be similar to the asset manager 106 of FIG. 1. Some of the components of the server 200 may be implemented in a single computing device or distributed over multiple computing devices. Some of the components may be in the form of virtual machines or software containers that are hosted in a cloud in communication with disaggregated storage devices.

The server 200 may include a communication interface 205, one or more processors 210, memory 215, and hardware 220. The communication interface 205 may include communication components that enable the server 200 to transmit data and receive data from other devices and networks. In some implementations, the communication interface 205 may be configured to communicate over a wide area network, a local area network, the internet, a wired connection, a wireless connection, and/or any other type of network or connection. The wireless connections may include Wi-Fi, short-range radio, infrared, and/or any other wireless connection.

The hardware 220 may include additional user interface, data communication, or data storage hardware. For example, the user interfaces may include a data output device (e.g., visual display, audio speakers), and one or more data input devices. The data input devices may include, but are not limited to, combinations of one or more of keypads, keyboards, mouse devices, touch screens that accept gestures, microphones, voice or speech recognition devices, and any other suitable devices.

The memory 215 may be implemented using computer-readable media, such as computer storage media. Computer-readable media includes, at least, two types of computer-readable media, namely computer storage media and communications media. Computer storage media includes volatile and non-volatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism.

The one or more processors 210 may implement a modification manager 225. The modification manager 225 may be similar to the modification manager 110 of FIG. 1. The modification manager 225 may be configured to receive and respond to various requests from computing devices as well as generate and output requests to those and other computing devices. Some of the requests that the modification manager 225 may receive include requests to add an asset to a distributed ledger. Other requests may include those to determine whether a specific asset or group of assets has been modified since the modification manager 225 received the request to add the specific asset or group of assets to the distributed ledger and/or complied with that request.

The modification manager 225 may include an identifier manager 235. The identifier manager 235 may be configured to determine whether an identifier received in a request to add an asset associated to the distributed ledger is unique. In some implementations, the identifier manager 235 may be configured to access the distributed ledger to determine which identifiers the modification manager 225 has previously received requests to add to the distributed ledger and added the corresponding assets to the distributed ledger. In some implementations, the identifier manager 235 may store, in the memory 215, the identifiers of assets that have been stored in the distributed ledger. The identifier manager 235 may compare a received identifier to the identifiers stored in the memory 215 and/or the identifiers in the distributed ledger.

In some implementations, the identifier manager 235 may generate a unique identifier upon receiving a request to add an asset to the distributed ledger. In this case, the server 200 may receive a request to add an asset to the distributed ledger and a request to generate an identifier for the asset. The identifier manager 235 may generate a unique identifier that is different that previously used identifiers. The identifier manager 235 may proceed with adding the asset to the distributed ledger and provide notification to the asset of the selected identifier. In some implementations, the identifier manager 235 may generate a unique identifier based on various pieces of data that may include a model of the asset, a location of the asset, a serial number of the asset, a phone number of the asset, a date and/or time of the request, and/or any other similar data. In some implementations, the identifier manager 235 may request that the asset provide data such as a model of the asset, a location of the asset, a serial number of the asset, a phone number of the asset, IMEI, MEID and/or any other similar data.

In some implementations, the modification manager 225 may be configured to provide an update to the distributed ledger related to an asset that was previously added to the distributed ledger. In this case, the modification manager 225 may receive a request that includes an identifier of the asset and data indicating that the asset has been modified. A process like this may occur if a user discovers a vulnerability in the software of the asset. The user may attempt to correct the vulnerability while also providing data indicating the update to the asset.

The process to provide an update to the distributed ledger related to an asset update may be similar to the initial addition of the asset to the distributed ledger with the addition of more metadata. In response to receiving the request to update the distributed ledger, the modification manager 225 may utilize the identifier manager 235, the signature manager 230, and/or the vulnerability assessor 240. The identifier manager 235 may be responsible to confirming that the identifier of the asset has been previously added to the distributed ledger and that this addition to the distributed ledger should reference the same identifier. The identifier manager 235 may determine that the matching identifier references the same device because the request may indicate that the asset has previously transmitted a request to add the asset. The request may include a timestamp of that previous request. With the timestamp and the identifier, the identifier manager 235 may confirm that the distributed ledger includes the asset. If the identifier manager 235 determines that the distributed ledger does not include the asset, then the identifier manager 235 may initiate the procedure to add the asset to the distributed ledger for a first time.

Updating the distributed ledger may also involve including a digital signature of the user providing the update and/or providing the server 200 notification of the update. The signature manager 230 may ensure that a user providing the update and/or providing the server 200 notification of the update provides a digital signature that will allow subsequent users to determine who updated and/or provided the notification of the update. The signature manager 230 may request a digital signature in response to the modification manager 225 receiving and identifying a request to provide an update the distributed ledger. The signature manager 230 may request a digital signature from the user providing the update and/or providing the server 200 notification of the update. The signature manager 230 may confirm that the digital signature is valid. If the digital signature is valid, then the signature manager 230 may provide the digital signature to the modification manager 225. If the digital signature is not valid, then the signature manager 230 may request another digital signature. If the signature manager 230 is unable to verify a digital signature, then the signature manager 230 may indicate to the modification manager 225 that no valid signature is available.

The vulnerability assessor 240 may be configured to determine a type of update provided to the asset. In some instances, the vulnerability assessor 240 may be configured to verify the type of update based on data provide by the user providing the update and/or providing the server 200 notification of the update. For example, the user may indicate that the update addresses a specific vulnerability. The vulnerability assessor 240 may be configured to access a vulnerability database that identifies known vulnerabilities. The vulnerability assessor 240 may ensure that the specified vulnerability matches a known vulnerability in the database. If that is that case, then the vulnerability assessor 240 may provide the modification manager 225 data indicating the vulnerability addressed by the update. If the specified vulnerability does not match a known vulnerability in the database, then the vulnerability assessor 240 may request that the user provide data to change the identification of the vulnerability and/or provide the modification manager 225 data indicating the alleged vulnerability addressed by the update is not a known vulnerability in the vulnerability database.

In some implementations, the vulnerability assessor 240 may be configured to analyze the update provided to the asset. In this case, the vulnerability assessor 240 may determine the vulnerability addressed by the update by analyzing the update. The vulnerability assessor 240 may use various tools to determine the addressed vulnerability. In this case, the vulnerability assessor 240 may not receive data identifying the vulnerability from the user. The vulnerability assessor 240 may utilize machine learning models trained on various vulnerabilities and corresponding software to determine the likely vulnerability addressed by the update. In this case, the models may be configured to receive various types of data including the software before the update, the software after the update, the specific update included in the software, the software removed, the portion of the software that was changed by the update before the update was applied, the hash of the software before the update, the hash of the software after the update, the hash of the specific update included in the software, the hash of the software removed, the hash of the portion of the software that was changed by the update before the update was applied, the model of the asset, the location of the asset, an identity of the user providing the update, a location of the user providing the update, a date and time of providing the update, a date and time of any previous update, an owner of the asset, a unique identifier of the asset, data identifying previous updates applied to the asset, and/or any other similar data. The models may be configured to output data indicating the vulnerability addressed by the update.

In some implementations, the vulnerability assessor 240 may be configured to train the models using machine learning and historical data. The historical data may include data related to previous assets and vulnerabilities. The data related to the previous assets may include the software before the update, the software after the update, the specific update included in the software, the software removed, the portion of the software that was changed by the update before the update was applied, the hash of the software before the update, the hash of the software after the update, the hash of the specific update included in the software, the hash of the software removed, the hash of the portion of the software that was changed by the update before the update was applied, the model of the asset, the location of the asset, an identity of the user providing the update, a location of the user providing the update, a date and time of providing the update, a date and time of any previous update, an owner of the asset, a unique identifier of the asset, data identifying previous updates applied to the asset, and/or any other similar data. The data may include labels that identify the vulnerability addressed by the update. The vulnerability assessor 240 may train the models using the labeled historical data. The resulting models may be configured to receive data similar to the data related to the previous assets and output a likely vulnerability addressed by the update.

In some implementations, the update may not address a vulnerability. Instead, the update may provide additional functionality. In this case, the vulnerability assessor 240 may provide, to the modification manager 225, data identifying the additional functionality provided by the update. In some implementations, the vulnerability assessor 240 may use similar techniques to identify the additional functionality as described above with respect to identifying the vulnerability. For example, the vulnerability assessor 240 may train and use machine learning models that are configured to receive the software before the update, the software after the update, the specific update included in the software, the software removed, the portion of the software that was changed by the update before the update was applied, the hash of the software before the update, the hash of the software after the update, the hash of the specific update included in the software, the hash of the software removed, the hash of the portion of the software that was changed by the update before the update was applied, the model of the asset, the location of the asset, an identity of the user providing the update, a location of the user providing the update, a date and time of providing the update, a date and time of any previous update, an owner of the asset, a unique identifier of the asset, data identifying previous updates applied to the asset, and/or any other similar data and output data identifying the additional functionality. The vulnerability assessor 240 may train the models using this data and labels that indicate the feature added.

With a digital signature of the user associated with the update and data identifying the vulnerability addressed by and/or feature added by the update, the modification manager 225 may be configured to add additional data to the distributed ledger in the form of an NFT. The modification manager 225 may utilize the hash generator 245 and the NFT generator 255 to generate the NFT and the additional data to include in the metadata of the NFT. The modification manager 225 may provide the hash generator 245 with instructions to generate the hash of the asset. The modification manager 225 may also provide the NFT generator 255 with instructions to generate an additional NFT for the asset. The modification manager 225 may also provide the NFT generator 255 the digital signature of the user associated with the update, the data identifying the vulnerability addressed by and/or feature added by the update, and/or the identifier of the asset as data to include in the metadata of the NFT.

The hash generator 245 may receive the instructions to generate a hash of the asset from the modification manager 225. The one or more processors 210 may implement the hash generator 245. The hash generator 245 may be similar to the hash generator 112 of FIG. 1. The hash generator 245 may generate the hash of the asset using a similar technique as described above with respect to FIG. 1. The hash generator 245 may include an parameter selector 250. The parameter selector 250 may be configured to select the data for the hash generator 245 to apply to the hash function. The parameter selector 250 may be configured to identify the type of asset. Based on the type of asset, the parameter selector 250 may select a parameter, or argument, for the hash function. In some implementations, the parameter selector 250 may be configured to select the same argument for each asset of the same type. For example, the parameter selector 250 may identify the asset as a mobile phone. For mobile phones, the parameter selector 250 may select as the argument the software stored in the non-volatile memory. As another example, the parameter selector may identify the asset as an NFT. For NFTs, the parameter selector 250 may select as the argument the block in the blockchain where the NFT is stored. The block may include the hash of the previous block, the metadata of the NFT, a timestamp stored in the block, and/or any other similar data in the block. As another example, the parameter selector may identify the asset as a digital video. For digital videos, the parameter selector 250 may select the file that includes the digital video and any related metadata as the argument.

In some implementations, the parameter selector 250 may be configured to include, in the argument for the hash function, additional data that may not be stored on a stored device of the asset. Some devices may include RFID tags, QR codes, barcodes, and/or any other similar object that may be configured to store information that may not be read directly by a processor of the asset. The parameter selector 250 may be configured to include this additional data with data stored in a storage device and provide the combined data to the hash function. The parameter selector 250 may follow a convention that may specify that the additional data precedes the data stored in the storage device for the purposes of selecting the hash argument. The parameter selector 250 may be configured to determine more than one hash value. A first hash value may be a hash of the RFID tags, QR codes, barcodes, and/or any other similar object. A second hash value may be a hash of the software and/or other data stored in a storage device.

The NFT generator 255 may receive instructions to generate an NFT of the asset from the modification manager 225. The one or more processors 210 may implement the NFT generator 255. The NFT generator 255 may be similar to the NFT generator 114 of FIG. 1. The NFT generator 255 may generate the NFT of the asset using a similar technique as described above with respect to FIG. 1. The NFT generator 255 may include a metadata manager 260. The metadata manager 260 may be configured select the metadata to include in the NFT. The metadata manager 260 may select the metadata based on the type of asset. For example, the metadata manager 260 may determine that the asset is a mobile phone. In this case, the metadata manager 260 may determine to select the hash of the mobile phone, the identifier of the mobile phone, the model of the mobile phone, and/or any other similar information. As another example, the metadata manager 260 may determine that the asset is an NFT. In this case, the metadata manager 260 may select the hash of the NFT, the identifier of the NFT, the type of data stored or referenced by the NFT, and/or any other similar information. As another example, the metadata manager 260 may identify the asset as a digital video. For digital videos, the metadata manager 260 may select the hash of the digital video file, the name of the video, locations where the video may be viewed, a creator of the video, and/or any other similar information.

In instances where the NFT generator 255 receives instructions to generate an additional NFT for an asset as may be the case if the asset has received an update, then the metadata manager 260 may select additional metadata for the NFT metadata. The additional metadata may include the hash of the previous version of the asset, the hash of the current version of the asset, the digital signature of the user who modified the asset, the hash of the updated software loaded to the asset, the hash of the software replaced or updated on the asset, the hash of the one or more previous NFTs for the asset, the locations of the one or more previous NFTs in the distributed ledger, the metadata of the one or more previous NFTs of the distributed ledger, and/or any other similar data. In the case of a nefarious actor modifying the asset, the server 200 may not receive any indication of the modification. In this case, the NFT generator 255 may not add an additional NFT to the distributed ledger because the server 200 did not receive notice of the modification.

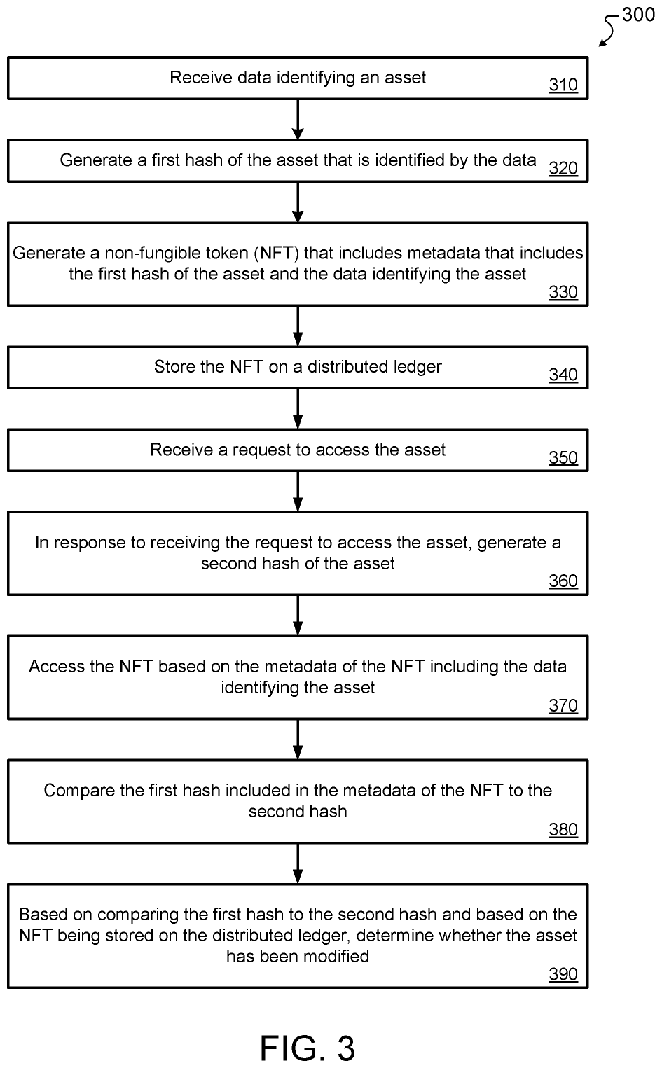

FIG. 3 is a flowchart of an example process 300 to track assets and provide data indicating whether the assets have been modified. In general, the process 300 receives data identifying an asset. The process 300 generates a hash of the asset and an NFT for the asset that includes the hash. The process 300 stores the NFT in a distributed ledger. After storing the NFT, the process 300 may receive a request to verify that the asset has not been modified. The process 300 may access the hash and compute a new hash of the asset. Based on the comparison between the hash and the new hash, the process 300 may determine whether the asset has been modified. The process 300 will be described as being performed by the asset manager 106 of FIG. 1 and will include references to components of the FIG. 1. In some implementations, the process 300 may be performed by the server 200 of FIG. 2.

The asset manager 106 receives data identifying an asset (310). In some implementations, the asset may be a physical asset such as a computing device or any other type of object that is configured to store computer readable data. In some implementations, the asset may be a virtual asset, such as an electronic document, digital video, digital audio, digital image, NFT, and/or any other similar type of object that is configured to be stored on computer readable storage. The data identifying the asset may be a unique identifier of the asset. For a physical asset, this may be a serial number that may include a model number, an IMEI, an MEID, and/or any other unique data. For a virtual asset, this may be a hash of a title, hash of a name, hash of the data of the virtual asset, and/or any other unique data.

The asset manager 106 generates a first hash of the asset that is identified by the data (320). Depending on the type of asset, the asset manager 106 may generate the first hash in different manners. For example, the asset manager 106 may generate a hash of the software stored on a physical asset, such as a computing device. As another example, the asset manager 106 may generate a hash of a digital file. As another example, the asset manager 106 may generate a hash of an NFT that may or may not include the data of the block in the blockchain where the NFT is located.

The asset manager 106 generates a non-fungible token (NFT) that includes metadata that includes the first hash of the asset and the data identifying the asset (330). In some implementations, the asset manager 106 may include additional metadata such as data identifying previous NFTs associated with the asset and data stored in those previous NFTs, a timestamp of the NFT and/or hash generation, a digital signature of a user who may be updating the asset, and/or any other similar data.

The asset manager 106 stores the NFT on a distributed ledger (340). In some implementations, the distributed ledger may be a blockchain. In the case of the asset being an NFT, this may allow for an NFT to move from one blockchain to another blockchain.

The asset manager 106 receives a request to access the asset (350). The request may originate from a user who wishes use, acquire, and/or verify that the asset has not been modified. In response to receiving the request to access the asset, the asset manager 106 generates a second hash of the asset (360). The asset manager 106 may generate the second hash in a similar manner to the first hash.

The asset manager 106 accesses the NFT based on the metadata of the NFT including the data identifying the asset (370). The asset manager 106 may receive the data identifying the asset from the user who originates the request. With the data identifying the asset, the asset manager 106 may be able to identify the NFT for that asset because the metadata of the NFT includes the data identifying the asset.

The asset manager 106 compares the first hash included in the metadata of the NFT to the second hash (380). In some implementations, the first hash matches the second hash. In some implementations, the first hash does not match the second hash.

Based on comparing the first hash to the second hash and based on the NFT being stored on the distributed ledger, the asset manager 106 determines whether the asset has been modified (390). If the first hash matches the second hash, then the asset manager 106 determines that the asset has not been modified. If the first hash does not match the second hash, then the asset manager 106 determines that the asset has been modified. The asset manager 106 may output the determination to the user who transmitted the request to access the asset.

In some implementations, the distributed ledger may include more than one NFT for the asset. This may be the case where the asset was modified and the asset manager 106 stored an additional NFT for the asset that included a new hash, data identifying a user who modified the asset, the modification to the asset, and/or any other similar information. In this case, the asset manager 106 may determine that the asset has been modified. In the output to the user indicating that the asset has been modified, the asset manager 106 may include data identifying the user who modified the asset, data identifying the modification, and/or any other similar information that may be included in the NFTs of the asset.

Although a few implementations have been described in detail above, other modifications are possible. In addition, the logic flows depicted in the figures do not require the particular order shown, or sequential order, to achieve desirable results. In addition, other actions may be provided, or actions may be eliminated, from the described flows, and other components may be added to, or removed from, the described systems. Accordingly, other implementations are within the scope of the following claims.

What is claimed is:

1. A computer-implemented method, comprising:
receiving, by an asset management system, data identifying an asset;
generating, by the asset management system, a first hash of the asset that is identified by the data;
generating, by the asset management system, a non-fungible token (NFT) that includes metadata that includes the first hash of the asset and the data identifying the asset;
storing, by the asset management system, the NFT on a distributed ledger;
receiving, by the asset management system, a request to access the asset;
in response to receiving the request to access the asset, generating, by the asset management system, a second hash of the asset;
accessing, by the asset management system, the NFT based on the metadata of the NFT including the data identifying the asset;
comparing, by the asset management system, the first hash included in the metadata of the NFT to the second hash; and
based on comparing the first hash to the second hash and based on the NFT being stored on the distributed ledger, determining, by the asset management system, whether the asset has been modified.

2. The method of claim 1, further comprising:
based on comparing the first hash to the second hash and based on the NFT being stored on the distributed ledger, determining, by the asset management system, that the first hash does not match the second hash,
wherein determining whether the asset has been modified comprises determining that the asset has been modified based on the first hash not matching the second hash.

3. The method of claim 1, further comprising:
determining, by the asset management system, that the distributed ledger includes additional data indicating a modification made to the asset and data identifying a user who modified the asset.

4. The method of claim 1, further comprising:
based on comparing the first hash to the second hash and based on the NFT being stored on the distributed ledger, determining that the first hash matches the second hash,
wherein determining whether the asset has been modified comprises determining that the asset has not been modified based on the first hash matching the second hash.

5. The method of claim 1, wherein:
receiving the data identifying the asset comprises receiving data identifying a computing device, and
generating the first hash of the asset comprises generating a hash of software stored on the computing device.

6. The method of claim 1, wherein:
receiving the data identifying the asset comprises receiving data identifying a document, and
generating the first hash of the asset comprises generating a hash of document.

7. The method of claim 1, wherein:
receiving the data identifying the asset comprises receiving data identifying an additional NFT on an additional distributed ledger, and
generating the first hash of the asset comprises generating a hash of the additional NFT.

8. A system, comprising:
one or more processors; and
memory including a plurality of computer-executable components that are executable by the one or more processors to perform a plurality of actions, the plurality of actions comprising:
receiving, by an asset management system, data identifying an asset;
generating, by the asset management system, a first hash of the asset that is identified by the data;
generating, by the asset management system, a non-fungible token (NFT) that includes metadata that includes the first hash of the asset and the data identifying the asset;
storing, by the asset management system, the NFT on a distributed ledger;
receiving, by the asset management system, a request to access the asset;
in response to receiving the request to access the asset, generating, by the asset management system, a second hash of the asset;
accessing, by the asset management system, the NFT based on the metadata of the NFT including the data identifying the asset;
comparing, by the asset management system, the first hash included in the metadata of the NFT to the second hash; and
based on comparing the first hash to the second hash and based on the NFT being stored on the distributed ledger, determining, by the asset management system, whether the asset has been modified.

9. The system of claim 8, wherein the actions comprise:
based on comparing the first hash to the second hash and based on the NFT being stored on the distributed ledger, determining, by the asset management system, that the first hash does not match the second hash,
wherein determining whether the asset has been modified comprises determining that the asset has been modified based on the first hash not matching the second hash.

10. The system of claim 8, wherein the actions comprise:
determining, by the asset management system, that the distributed ledger includes additional data indicating a modification made to the asset and data identifying a user who modified the asset.

11. The system of claim 8, wherein the actions comprise:
based on comparing the first hash to the second hash and based on the NFT being stored on the distributed ledger, determining that the first hash matches the second hash,
wherein determining whether the asset has been modified comprises determining that the asset has not been modified based on the first hash matching the second hash.

12. The system of claim 8, wherein:
receiving the data identifying the asset comprises receiving data identifying a computing device, and
generating the first hash of the asset comprises generating a hash of software stored on the computing device.

13. The system of claim 8, wherein:
receiving the data identifying the asset comprises receiving data identifying a document, and
generating the first hash of the asset comprises generating a hash of document.

14. The system of claim 8, wherein:
receiving the data identifying the asset comprises receiving data identifying an additional NFT on an additional distributed ledger, and
generating the first hash of the asset comprises generating a hash of the additional NFT.

15. One or more non-transitory computer-readable media of a computing device storing computer-executable instructions that upon execution cause one or more computers to perform acts comprising:
receiving, by an asset management system, data identifying an asset;
generating, by the asset management system, a first hash of the asset that is identified by the data;
generating, by the asset management system, a non-fungible token (NFT) that includes metadata that includes the first hash of the asset and the data identifying the asset;
storing, by the asset management system, the NFT on a distributed ledger;
receiving, by the asset management system, a request to access the asset;
in response to receiving the request to access the asset, generating, by the asset management system, a second hash of the asset;
accessing, by the asset management system, the NFT based on the metadata of the NFT including the data identifying the asset;
comparing, by the asset management system, the first hash included in the metadata of the NFT to the second hash; and
based on comparing the first hash to the second hash and based on the NFT being stored on the distributed ledger, determining, by the asset management system, whether the asset has been modified.

16. The media of claim 15, wherein the acts comprise:
based on comparing the first hash to the second hash and based on the NFT being stored on the distributed ledger, determining, by the asset management system, that the first hash does not match the second hash,
wherein determining whether the asset has been modified comprises determining that the asset has been modified based on the first hash not matching the second hash.

17. The media of claim 15, wherein the acts comprise:
determining, by the asset management system, that the distributed ledger includes additional data indicating a modification made to the asset and data identifying a user who modified the asset.

18. The media of claim 15, wherein the acts comprise:
based on comparing the first hash to the second hash and based on the NFT being stored on the distributed ledger, determining that the first hash matches the second hash,
wherein determining whether the asset has been modified comprises determining that the asset has not been modified based on the first hash matching the second hash.

19. The media of claim 15, wherein:
receiving the data identifying the asset comprises receiving data identifying a computing device, and
generating the first hash of the asset comprises generating a hash of software stored on the computing device.

20. The media of claim 15, wherein:
receiving the data identifying the asset comprises receiving data identifying a document, and
generating the first hash of the asset comprises generating a hash of document.
